(19) United States
(12) Patent Application Publication
(10) Pub. No.: US 2016/0243986 A1
(43) Pub. Date: Aug. 25, 2016

(54) DISPLAY DEVICE AND DRIVING SUPPORT DEVICE

(71) Applicant: TOYOTA JIDOSHA KABUSHIKI KAISHA, TOYOTA- SHI (JP)

(72) Inventors: Yoko ISHIGURO, Toyota-shi (JP); Kazunori HARIMA, Nisshin-shi (JP)

(73) Assignee: TOYOTA JIDOSHA KABUSHIKI KAISHA, Toyota-shi, Aichi (JP)

(21) Appl. No.: 15/030,504

(22) PCT Filed: Jan. 6, 2015
(86) PCT No.: PCT/JP2015/050183

§ 371 Date: Apr. 19, 2016

(30) Foreign Application Priority Data
Feb. 12, 2014 (JP) 2014-024388

(51) Int. Cl. B60R 1/00; H04N 7/18

(52) U.S. Cl. CPC B60R 1/00; H04N 7/183; B60R 2300/202; B60R 2300/802

(57) ABSTRACT

A display device includes a front pillar having a curved surface that is convex toward a vehicle cabin side, a curvature of the curved surface being smaller at a lower side in a vehicle vertical direction than at an upper side. The display device also includes a display portion provided at least at a lower portion in the vehicle vertical direction at the curved surface of the front pillar, an image being displayed on the display portion.

### TECHNICAL FIELD

The present disclosure relates to a display device and a driving support device.

### BACKGROUND ART

There is known a technique of displaying, on a display device that is provided at a front pillar, the image of a dead angle region of a driver that is formed by the front pillar (see, for example, Japanese Patent Application Laid-Open (JP-A) No. 2011-234095).

### SUMMARY OF INVENTION

### Technical Problem

In the above-described technique, the display portion is disposed so as to span over the corner portion (the ridgeline) at the vehicle cabin side of the front pillar, and there is room for improvement from the standpoint of the viewability due to distortion of the image.

An object of the present disclosure is to provide a display device and a driving support device that can suppress the feeling of strangeness that is given to a vehicle occupant and is caused by distortion of the image displayed on a display portion of a front pillar.

### Solution to Problem

A display device relating to a first aspect of the present invention comprises: a front pillar having a curved surface that is convex toward a vehicle cabin side, a curvature of the curved surface being smaller at a lower side in a vehicle vertical direction than at an upper side; and a display portion provided at least at a lower portion in the vehicle vertical direction at the curved surface of the front pillar, an image being displayed on the display portion.

In this display device, because the curvature of the lower portion of the curved surface, that is convex toward the vehicle cabin side, at the front pillar is small, there is little distortion of the image that is displayed on the display portion provided at that lower portion. Here, the region that a vehicle occupant gazes upon at the front pillar is the lower portion, and, because there is little distortion of the displayed image of the display portion that is provided at that lower portion, the feeling of strangeness given to the vehicle occupant can be suppressed. On the other hand, at the upper portion of the front pillar, a shape that corresponds to the requirements of the vehicle (e.g., the energy absorbing performance) can be employed.

In this way, the driving support device of the first aspect can suppress the feeling of strangeness that is given to a vehicle occupant due to distortion of the image displayed on the display portion of the front pillar.

In the above-described aspect, there may be a structure in which the display portion is provided so as to extend from the lower portion to an upper portion in the vehicle vertical direction at the curved surface of the front pillar.

In this display device, the display portion is provided so as to extend from the lower portion to the upper portion at the curved surface of the front pillar. Therefore, an image can be displayed on the wide surface, that faces the vehicle cabin side, of the front pillar.

In the above-described aspect, there may be a structure in which a portion of a curtain airbag is accommodated at an upper portion in the vehicle vertical direction of an interior of the front pillar.

In this display device, the curtain airbag is accommodated where the curvature of the curved surface at the front pillar is large, or, in other words, at the upper portion of the front pillar that protrudes-out greatly toward the vehicle cabin side. Due thereto, both the ability to accommodate the curtain airbag, and suppressing of the feeling of strangeness that is given to the vehicle occupant due to the above-described distortion of the image, can both be achieved.

In the above-described aspect, there may be a structure in which the curvature of the curved surface is gradually decreased from the upper side toward the lower side in the vehicle vertical direction.

In this display device, the curvature of the curved surface is gradually decreased (gently decreased, continuously decreased) from the upper side toward the lower side in the vertical direction. Therefore, the display portion, at which the feeling of strangeness given to the vehicle occupant due to the above-described distortion of the image is suppressed, can be formed without marring the appearance of the front pillar.

A driving support device relating to a second aspect comprises: an imaging unit capturing a region that is a dead angle for a driver due to the front pillar; and the display device of any of the above-described respective aspects that has a projecting unit projecting an image captured by the imaging unit toward the display portion, and that projects and displays a projected image of the projecting unit onto the display portion.

In this driving support device, at least a portion of the vehicle outer side region, that is a dead angle to the driver who is a vehicle occupant, is captured by the imaging unit, and the image that is captured by the imaging unit is displayed by being projected onto the display portion that is provided at the driver's side of the front pillar that gives rise to this dead angle. Here, because the display device of any of Claim 1 through Claim 4 is utilized, the feeling of strangeness, that is given to the driver due to distortion of dead angle image that is displayed on the display portion of the front pillar, can be suppressed.

### Advantageous Effects of Invention

As described above, the display device and the driving support device relating to the present disclosure have the excellent effect of being able to suppress the feeling of strangeness that is given to a vehicle occupant due to distortion of the image displayed on the display portion of the front pillar.

### BRIEF DESCRIPTION OF DRAWINGS

FIG. 1A is a plan view that schematically shows, in an enlarged manner, main portions of a visual information supplementing device relating to an embodiment, and is a cross-sectional view along line 1A-1A of FIG. 2.

FIG. 1B is a plan view that schematically shows, in an enlarged manner, main portions of the visual information supplementing device relating to the embodiment, and is a cross-sectional view along line 1B-1B of FIG. 2.

FIG. 1C is a plan view that schematically shows, in an enlarged manner, main portions of the visual information supplementing device relating to the embodiment, and is a cross-sectional view along line 1C-1C of FIG. 2.

FIG. 2 is a side view schematically showing the overall structure of the visual information supplementing device relating to the embodiment.

FIG. 3 is a plan view schematically showing the overall structure of the visual information supplementing device relating to the embodiment.

FIG. 4 is a perspective view schematically showing a state of displaying a dead angle image on a screen of the visual information supplementing device relating to the embodiment.

### DESCRIPTION OF EMBODIMENTS

A visual information supplementing device 10, that serves as an example of a driving support device relating to an embodiment of the present disclosure, is described on the basis of the drawings. Note that arrow FR, arrow UP, arrow RH and arrow LH that are marked appropriately in the respective drawings indicate, respectively, the frontward direction, the upward direction, and the rightward direction and the leftward direction in a case of facing in the frontward direction of an automobile to which the visual information supplementing device 10 is applied. Hereinafter, when simply longitudinal, vertical and left-right directions are used, they mean the longitudinal of the vehicle longitudinal direction, the vertical of the vehicle vertical direction, and the left and the right in a case of facing in the frontward direction, unless otherwise indicated.

[General Structure of Vehicle]

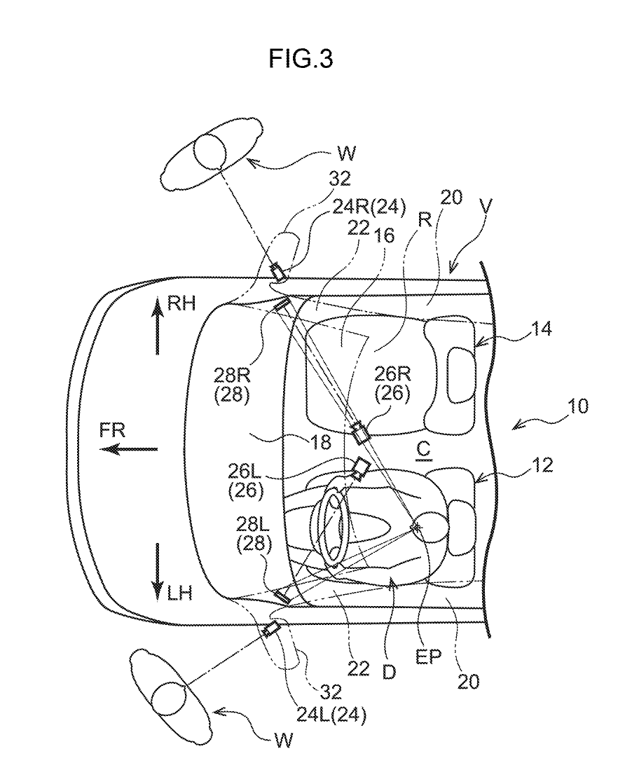

As shown in FIG. 3, a driver's seat 12 and a front passenger's seat 14 are provided within a cabin C that is the vehicle cabin of an automobile V that serves as an example of a vehicle to which the visual information supplementing device 10 is applied. In this embodiment, the driver's seat 12 is disposed at the left side with respect to the vehicle transverse direction center of the automobile V. A windshield glass 16 and an instrument panel 18 are disposed in front of the driver's seat 12. Further, side window glasses 20 are respectively disposed at the vehicle transverse direction outer sides of the driver's seat 12 and the front passenger's seat 14.

Further, front pillars 22 (and unillustrated door frames) are disposed between the windshield glass 16 and the left and right side window glasses 20. These left and right front pillars 22, together with a roof header portion and a cowl portion, structure the window frame at which the visual field is ensured by the windshield glass 16. Further, the left and right front pillars 22, together with door frames of side doors and the like, respectively structure window frames at which the visual field is ensured by the side window glasses 20. These left and right front pillars 22 can be considered to be skeleton (window frame) members that create (give rise to) dead angles with respect to the vehicle occupant seated in the driver's seat 12, i.e., a driver D.

[Visual Information Supplementing Device]

The visual information supplementing device 10 is structured so as to cause the driver D to see visual information of the vehicle outer side regions, that become dead angles to the driver D due to the front pillars 22, by displaying the visual information on the front pillars 22. Concrete description is given hereinafter.

The visual information supplementing device 10 is structured to include CCD cameras 24 that serve as examples of an imaging unit, and a display device 11. Further, the display device 11 is structured to include projectors 26 that serve as examples of projecting unit, and screens 28 that serve as examples of display portions that form projected-on surfaces at the front pillars 22. Note that the CCD cameras 24, the projectors 26, and the screens 28 are respectively provided as left/right pairs. In the following description, when differentiating between the CCD cameras 24, the projectors 26 and the screens 28 at the left and the right, “L” is added to the end of the reference numeral of that on the left side, and “R” is added to the end of the reference numeral of that on the right side.

The CCD camera 24L at the left side is disposed so as to face in the sightline direction from the driver D toward the left side front pillar 22 side, and captures the region that is obliquely forward and to the left of the cabin C, and outputs image information of the captured image to the projector 26L. The CCD camera 24R at the right side is disposed so as to face in the sightline direction from the driver D toward the right side front pillar 22 side, and captures the region that is obliquely forward and to the right of the cabin C, and outputs image information of the captured image to the projector 26R. The left and right CCD cameras 24 are disposed, for example, within door mirror devices 32 or within the lower portions of the front pillars 22, at the sides corresponding to the left and the right respectively

Image information is inputted wirelessly or by wires from the CCD camera 24L to the projector 26L at the left side, and the projector 26L at the left side projects an image, that is based on this image information, toward the screen 28L. Image information is inputted wirelessly or by wires from the CCD camera 24R to the projector 26R at the right side, and the projector 26R at the right side projects an image, that is based on this image information, toward the screen 28R. Note that, although not illustrated, the left and right projectors 26 are mounted to the roof portion of the automobile V (between the roof and the roof head lining, or at an overhead console, or the like).

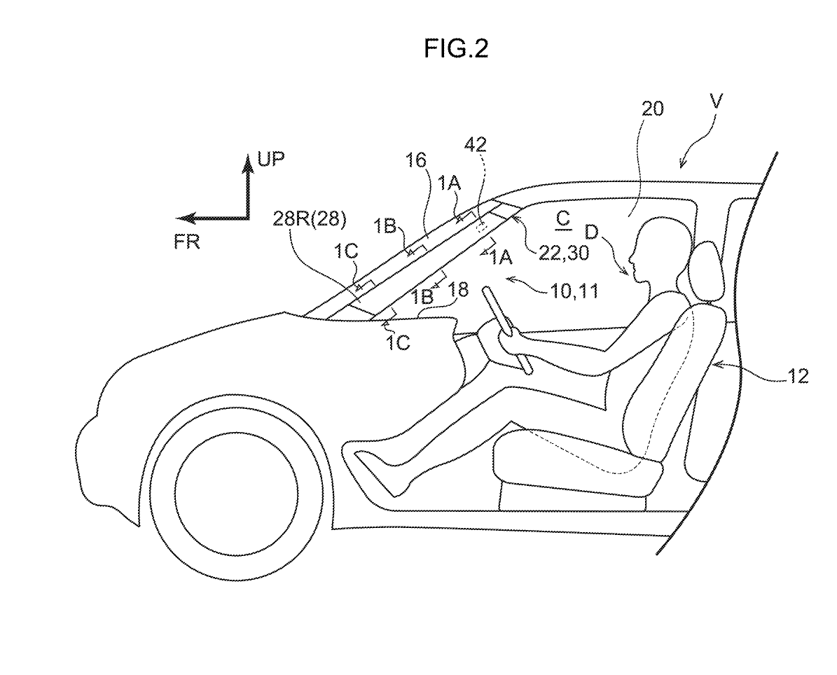

The images that the corresponding projectors 26 project are projected onto the left and right screens 28. As shown in FIG. 2, these screens 28 are provided at the surfaces of pillar garnishes 30 that serve as examples of interior finishing parts and that structure the front pillars 22, or these screens 28 structure the surfaces of the pillar garnishes 30 (are formed integrally with the surfaces). In this embodiment, the screen 28L at the left side is provided at the surface of the pillar garnish 30 at the left side, and the screen 28R at the right side is provided at the surface of the pillar garnish 30 at the right side.

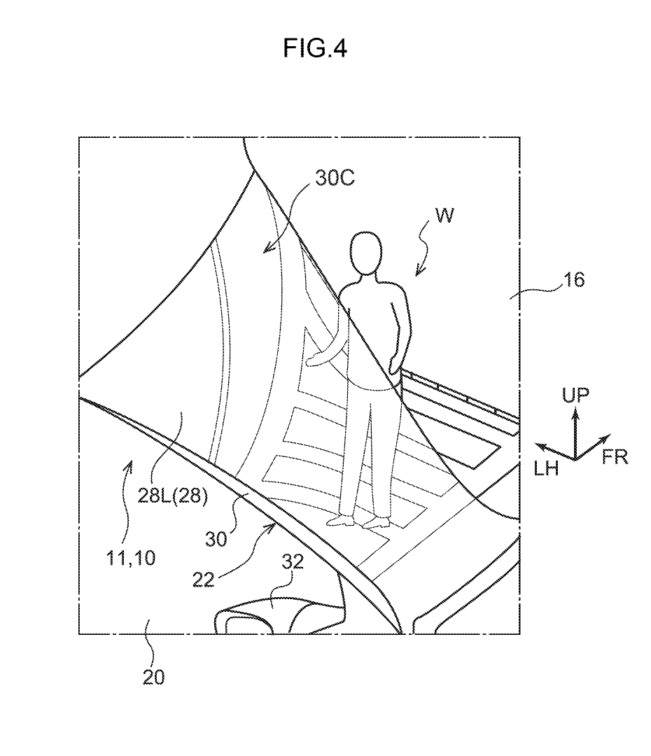

Further, in this embodiment, the screen 28 is provided over substantially the entire region in the transverse direction at the front pillar 22 including the pillar garnish 30, when viewed from the driver D. In other words, the screen 28 is made to be a structure that occupies a range extending over substantially the entire width of the front pillar 22 as seen from the driver D (overlaps from a transverse direction one end to the other end of the front pillar 22). Due thereto, as shown in FIG. 4, the visual information supplementing device 10 is structured so as to cause the driver D to view the image of the region, that is a dead angle for the driver D, and the actual view continuously and substantially without breaks.

As shown in FIG. 2, the screen 28R at the right side reaches from a vicinity of the upper end of the pillar garnish 30 to a vicinity of the lower end, and is disposed so as to occupy a wide range of that pillar garnish 30 in the vertical direction. Although not illustrated, the screen 28L at the left side reaches from a vicinity of the upper end of the pillar garnish 30 to a vicinity of the lower end, and is disposed so as to occupy a wide range of that pillar garnish 30 in the vertical direction.

(Detailed Structures of Front Pillar and Screen)

The screen 28 that structures the above-described visual information supplementing device 10, and the front pillar 22 at which the screen 28 is provided, are described in detail. Note that, because the structures (the design concepts) of the left and right screens 28L, 28R are basically similar, in the following description, the screen 28 will be described in the singular without distinguishing between the left and right screens 28.

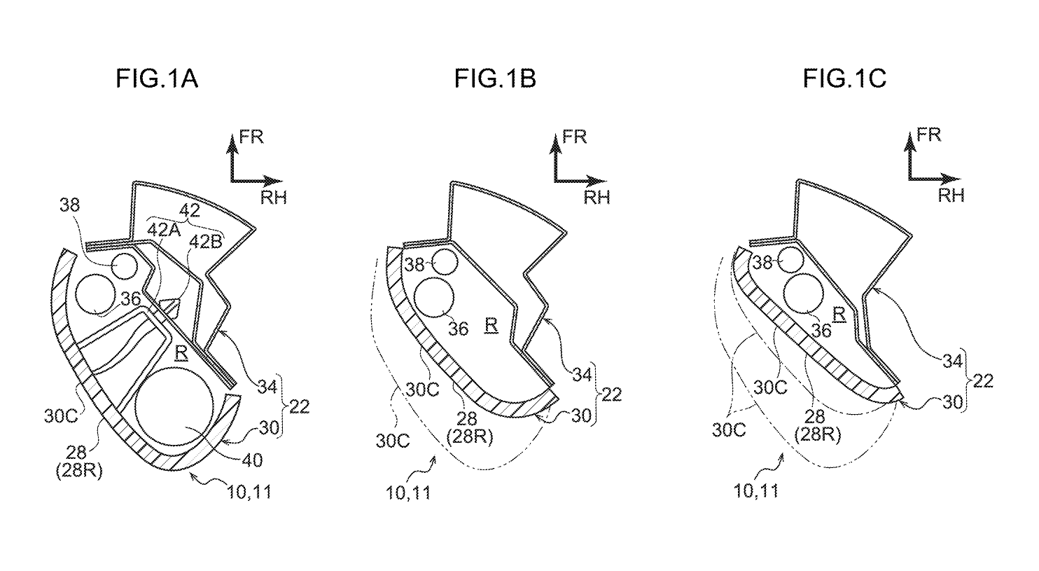

As shown in FIG. 1A through FIG. 1C, the front pillar 22 is structured to include a pillar main body 34 that is a skeleton member of the vehicle body, and the pillar garnish 30 that covers the pillar main body 34 from the cabin C side. The pillar main body 34 is formed from a steel material, and is a closed cross-sectional structural body at which the cross-section orthogonal to the length direction is a closed cross-sectional shape. A space R is formed between the pillar garnish 30 and the pillar main body 34 in a state in which the pillar garnish 30 is mounted to the pillar main body 34 by a mounting structure 42 and the like that are described later.

In this embodiment, a wire harness 36 for electrical wiring, and a drain hose 38 for discharging rain water and the like, are passed-through the interior of the space R. Further, as shown in FIG. 1A, the front portion of a curtain airbag 40 is accommodated within the space R at the upper portion of the front pillar 22. The curtain airbag 40 is structured to include a portion that is accommodated along an unillustrated roof side rail.

This curtain airbag 40 is a structure that, at the time of for example, a front collision, an oblique collision, a side collision, a rollover, or the like of the automobile V, receives a supply of gas from an unillustrated inflator, and is inflated and expanded within the cabin C along the side window glass 20. When the portion, that is accommodated within the space R of the front pillar 22, of the curtain airbag 40 is inflated and expanded, this portion prevents the head portion of the vehicle occupant from directly colliding with the front pillar 22.

Further, the mounting structure 42 for mounting the pillar garnish 30 to the pillar main body 34 is disposed within the space R at the upper portion of the front pillar 22. The mounting structure 42 is structured to include a mounting seat portion 42A that is provided at the pillar garnish 30, and a tether clip 42B that passes-through the pillar main body 34 and is anchored to the mounting seat portion 42A. The mounting structure 42 is a structure that mounts the pillar garnish 30 to the pillar main body 34 such that separation of the pillar garnish 30 from the pillar main body 34 (expansion of the curtain airbag 40 toward the cabin C) due to the inflation pressure of the curtain airbag 40 is permitted. Further, the mounting structure 42 is a structure at which, due to use of the tether clip 42B, the pillar garnish 30 that has separated from the pillar main body 34 is prevented from falling-off of the pillar main body 34.

At the upper portion of the front pillar 22 where the curtain airbag 40 is accommodated and the mounting structure 42 is disposed in this way, the (sectional surface area of the) space R is set to be larger than at the lower portion. Therefore, in a cross-sectional view intersecting (orthogonal to) the length direction of the front pillar 22, the cabin C side surface of the pillar garnish 30 is made to be a curved surface 30C (see FIG. 1, FIG. 3) at which the cabin C side edge portion is a curve that is convex toward the cabin C side. At the upper portion thereof, the curved surface 30C is curved at a curvature that is larger than at the lower portion, and, at the upper portion thereof, the curved surface 30C protrudes-out more greatly into the cabin C than at the lower portion. In other words, the curvature of the pillar garnish 30, i.e., the curved surface 30C of the front pillar 22, is smaller at the lower portion thereof than at the upper portion. The curvatures of (the respective portions in the vertical direction of) the curved surface 30C mean the curvatures of the cabin C side edge portion in cross-sections of the pillar garnish 30 that intersect (are orthogonal to) the length direction of the front pillar 22.

Here, the imaginary lines in FIG. 1B and FIG. 1C show the protruding shape, toward the vehicle cabin inner side, of the pillar garnish 30 in FIG. 1A. Further, the one-dot chain line in FIG. 1C shows the protruding shape, toward the vehicle cabin inner side, of the pillar garnish 30 in FIG. 1B. In this way, the curvature of the pillar garnish 30 is gradually decreased (gently decreased, continuously decreased) from the upper side toward the lower side.

Moreover, as described above, the screen 28 is formed along the curved surface 30C that is convex toward the cabin C side at the pillar garnish 30, or is formed by the curved surface 30C itself. Accordingly, in the same way as the pillar garnish 30, the curvature of the screen 28 is made to be smaller at the lower portion thereof than at the upper portion. Namely, as shown in FIG. 1A, the upper portion of the screen 28 is a curved surface of a large curvature, and, as shown in FIG. 1C, the lower portion of the screen 28 is a curved surface of a small curvature (that is substantially flat except for the transverse direction end portions). Further, as shown in FIG. 1B, the intermediate portion of the screen 28 is a curved surface of a curvature between those of the upper portion and the lower portion.

[Operation]

Operation of the embodiment is described next.

The driver D of the automobile V, to which is applied the visual information supplementing device 10 that includes the display device 11, drives the automobile V while checking safety on the basis of visual information that is seen through the windshield glass 16 and the left and right side window glasses 20.

Further, at the visual information supplementing device 10, the images captured by the left and right CCD cameras 24L, 24R are projected by the projectors 26, and are projected onto the left and right screens 28L, 28R (refer to FIG. 4 for the screen 28L at the left side). Then, the images projected on the left and right screens 28L, 28R are viewed by the driver D. Namely, the visual information (external view) of the regions (hereinafter called “dead angle regions”), that are dead angles due to the left and right front pillars 22, are displayed as images on the screens 28 that are provided at the front pillars 22.

Therefore, the driver D faces the direction that should be confirmed (the dead angle region), and can see the image that compensates for the dead angle region. Due thereto, as shown in FIG. 4 for example, even in a case in which a portion of a pedestrian W is in the dead angle of the front pillar 22, the visual information of the dead angle region is supplemented by the image projected on the screen 28L, and therefore, substantially the entire body of that pedestrian W can be seen. Thus, the driver D can notice (easily notice) the existence of the pedestrian W.

Here, at the visual information supplementing device 10 and the display device 11, because the curvature is small at the lower portion of the screen 28, an image having little distortion can be projected (displayed). Further, because the portion, that the driver D gazes on, of the screen 28 that is provided at the front pillar 22 is the lower portion, the feeling of strangeness that is given to the driver D can be suppressed by placing the display portion that has little distortion, i.e., the lower portion of the screen 28, at this lower portion.

In this way, in the visual information supplementing device 10 and the display device 11 relating to the present embodiment, the feeling of strangeness, that is given to the driver D due to distortion of the image displayed on the screen 28 that is set at the front pillar 22, can be suppressed.

On the other hand, the upper portion of the front pillar 22 is a region that the head portion of the driver D can contact at the time of, for example, a front collision or an oblique collision of the automobile V, and lowering of the injury value to the head portion is required thereof. In this embodiment, a reduction in the injury value to the head portion due to the curtain airbag 40 is devised by making the curvature of the upper portion of the pillar garnish 30 large and ensuring space for accommodating the curtain airbag 40 at the upper portion of the front pillar 22. From another standpoint, the curtain airbag 40 can be accommodated by effectively utilizing the space R that is wide at the upper portion of the front pillar 22.

Further, at the visual information supplementing device 10 and the display device 11, the screen 28 is provided so as to extend from the lower portion to the upper portion of the front pillar 22. Due thereto, visual information of a wide range can be supplemented by projecting the dead angle image onto the screen 28 that extends over a wide range of the front pillar 22 that gives rise to the dead angle region. Here, at the upper portion of the screen 28, although the displayed image is distorted as shown in FIG. 4, the region that the driver D gazes upon is the lower portion of the screen 28 as described above, and therefore, the feeling of strangeness that is given to the driver D is suppressed. To describe further, for example, information relating to safe driving of the automobile V (persons or things that are near the automobile V and are of a height that can interfere with the automobile V) is projected mainly onto the lower portion of the screen 28, and therefore, the driver D gazes upon the lower portion of the screen 28.

Further, because the dead angle image is displayed on the upper portion of the screen 28, it is easy for the driver D to receive the impression (the visual effect) that the front pillar 22 does not exist, as compared with a case in which a dead angle image is not displayed on the upper portion of the screen 28. Namely, by displaying the dead angle image on the wide range of the screen 28 that extends from a vicinity of the upper end to a vicinity of the lower end of the front pillar 22, the driver D can be made to feel as if there is a window that is continuous from the windshield glass 16 to the side window glass 20.

Moreover, at the visual information supplementing device 10 and the display device 11, the curvature of the screen 28 is gradually decreased from the upper side toward the lower side. Therefore, the screen 28, that suppresses the feeling of strangeness given to the driver D due to distortion of the displayed image, can be formed without marring the appearance of the front pillar 22 (the pillar garnish 30). For example, the appearance of the front pillar 22 (the pillar garnish 30) improves as compared with a structure in which the curvature of the pillar garnish 30 changes in a step-wise manner.

Note that the above-described embodiment illustrates an example in which an image is displayed by projecting the projected image from the projector 26 onto the screen 28, but the present disclosure is not limited to this. For example, a display, whose curvature is deformable and that is affixed to the curved surface of the pillar garnish 30 (a display means that displays an image generated by itself on the basis of image data), may be employed as the display device.

Further, although the above-described embodiment illustrates an example in which the curtain airbag 40 is accommodated within the space R at the upper portion of the front pillar 22, the present disclosure is not limited to this. For example, there may be a structure in which the pillar garnish 30 itself functions as an energy absorbing member that reduces the injury value to the head portion. In this structure as well, due to the curvature (the amount of protrusion toward the cabin C side) of the upper portion of the pillar garnish 30 being large, it is easy to ensure the energy absorbing stroke, and the (peak of the) load that is applied to the head portion at the time of energy absorption can be kept low.

Moreover, although the above-described embodiment illustrates an example in which the lower portion of the screen 28 is curved, the present disclosure is not limited to this. For example, there may be a structure in which (a fixed range of) the lower portion of the screen 28 is flat over the entire width thereof. In other words, the curved surface of the present disclosure may be structured to include, at a portion thereof, a flat surface (a surface whose curvature is 0, or a surface of an infinite radius of curvature). In this case as well, it is preferable that there be a structure in which the curvature is gradually reduced from the upper portion of the screen 28 to the upper end of the flat portion.

Still further, although the above-described embodiment illustrates an example in which the screen 28 is provided so as to extend from the lower portion to the upper portion of the front pillar 22, the present disclosure is not limited to this. It suffices for the display portion (the screen 28) of the present disclosure to be provided at least at the lower portion in the vehicle vertical direction at the curved surface 30C of the front pillar 22, and, for example, there may be a structure in which the screen 28 is not provided at the upper portion of the curved surface 30C of the front pillar 22. In other words, there may be a structure in which the screen 28 is provided only the lower portion of the curved surface 30C of the front pillar 22.

Further, the above-described embodiment illustrates an example in which the display device 11 relating to the present disclosure is applied to the visual information supplementing device 10 that serves as an example of a driving support device that projects a dead angle image onto the front pillar 22, but the present disclosure is not limited to this. It suffices for an embodiment of the present disclosure to display an image at least on the lower portion of the front pillar 22, and, for example, may be a structure that projects, onto at least the lower portion of the front pillar 22, an image in which the region at the rear of the vehicle at the time of reversing is captured, or an image in which the situation in the rear seat is captured. Further, the present disclosure is not limited to a structure that projects, onto an interior fitting part, an image that is captured by an imaging unit that is installed in the automobile, and, for example, the present disclosure may be applied to a structure that projects, onto at least the lower portion of the front pillar 22, map information or driving information (the vehicle speed or the like). Moreover, for example, the present disclosure may be applied to a structure that projects, onto an interior fitting part, the captured image of a camera that is on the road or that is set in another vehicle.

Moreover, although the above-described embodiment illustrates an example in which the CCD camera 24 is used as the imaging unit, the present disclosure is not limited to this and may utilize any imaging unit. Accordingly, for example, a CMOS camera or the like may be used instead of the CCD camera 24.

Still further, although the above-described respective embodiments illustrate an example in which the left and right CCD cameras 24 and projectors 26 and screens 28 are provided, the present disclosure is not limited to this. The visual information supplementing device 10 and the display device 11 may be structured so as to have the CCD camera 24, the projector 26, and the screen 28 at only one of the left and right sides for example.

In addition, it goes without saying that the present disclosure can be implemented by being modified in various ways within a scope that does not depart from the gist thereof.

Further, the disclosure of Japanese Patent Application No. 2014-024388 that was filed on Feb. 12, 2014 is, in its entirety, incorporated by reference into the present specification.

The relationships of correspondence between the reference numerals and the names of the respective portions that are used in the present specification are as follows.
10 visual information supplementing device
11 display device
22 front pillar
24 CCD camera (an example of the imaging unit)
26 projector (an example of the projecting unit)
28 screen (an example of the display portion)
30 pillar garnish (an example of the front pillar)
30C curved surface
40 curtain airbag
C cabin (vehicle cabin)

1. A display device comprising:
a front pillar having a curved surface that is convex toward a vehicle cabin side, a curvature of the curved surface being smaller at a lower side in a vehicle vertical direction than at an upper side; and
a display portion provided at least at a lower portion in the vehicle vertical direction at the curved surface of the front pillar, an image being displayed on the display portion.

2. The display device of claim 1, wherein the display portion is provided so as to extend from the lower portion to an upper portion in the vehicle vertical direction at the curved surface of the front pillar.

3. The display device of claim 1, wherein a portion of a curtain airbag is accommodated at an upper portion in the vehicle vertical direction of an interior of the front pillar.

4. The display device of claim 1, wherein the curvature of the curved surface is gradually decreased from the upper side toward the lower side in the vehicle vertical direction.

5. A driving support device comprising:
an imaging unit capturing a region that is a dead angle for a driver due to the front pillar; and
the display device of claim 1 that has a projecting unit projecting an image captured by the imaging unit toward the display portion, and that projects and displays a projected image of the projecting unit onto the display portion.
